(19) United States
(12) Patent Application Publication
(10) Pub. No.: US 2011/0217106 A1
(43) Pub. Date: Sep. 8, 2011

(54) INFORMATION OUTPUT APPARATUS, LABEL PRINTER AND INFORMATION OUTPUT METHOD

(75) Inventor: Hiroshi Shimomura, Shizuoka (JP)

(73) Assignee: TOSHIBA TEC KABUSHIKI KAISHA, Tokyo (JP)

(21) Appl. No.: 13/037,555

(22) Filed: Mar. 1, 2011

(30) Foreign Application Priority Data
Mar. 2, 2010 (JP) 2010-045646
Feb. 9, 2011 (JP) 2011-026328

(51) Int. Cl. B41J 11/44

(52) U.S. Cl. 400/76

(57) ABSTRACT

An information output apparatus includes a reception part, a determination part and an information output part. The reception part receives identification information of a product. The determination part reads a content of a nutrient contained in the product having the identification information received by the reception part from a storage part, compares the read content of the nutrient with a reference value indicating a display allowable range in which a display relating to the content of the nutrient may be performed, and determines whether the display relating the content of the nutrient may be performed for the product. When it is determined that the display relating the content of the nutrient may be performed for the product, the information output part outputs information relating to the content of the nutrient.

### CROSS-REFERENCE TO RELATED APPLICATION

This application is based upon and claims the benefit of priority from Japanese Patent Application No. 2010-45646 filed on Mar. 2, 2010; and Japanese Patent Application No. 2011-026328 filled on Feb. 9, 2011, the entire contents of all of which are incorporated herein by reference.

### FIELD

Embodiments described herein relate generally to an information output apparatus, a label printer and an information output method.

### BACKGROUND

In recent years, health conscious becomes strong, and it is requested to plainly display the contents of nutrients, calorie and the like contained in food to a consumer. JP-A-2000-255114 discloses a technique relating to a label printer which displays a graph indicating the degree of nutrients contained in a product relative to reference values and prints it.

However, when the graph is displayed as stated above, since all information relating to plural nutrients is included, there is a problem that when the product is selected from a showcase, the display is hard to see, and information desired to be known by the user is hard to discern at a glance.

On the other hand, with respect to a product which contains a rich nutrient or low calorie, when an emphasis display such as “Iron is rich” or “Calorie is low” is printed on a label, the information of the product can be plainly indicated to the consumer.

Incidentally, with respect to the degree of contents in which the emphasis display can be performed, an emphasis display allowable range in which the emphasis display can be performed is generally prescribed as a guideline of emphasis display, and the adequate emphasis display must be performed in accordance with this guideline.

### DESCRIPTION OF THE DRAWINGS

FIG. 1 is a perspective view showing an outer appearance of a label printer of an embodiment.

FIG. 2 is a perspective view showing a state where a first printer is pulled out from a body.

FIG. 3 is a block diagram showing a hardware structure of the label printer.

FIG. 4 is a view for explaining a product-by-product nutrient master.

FIG. 5 is a view showing an example of a reference value table.

FIG. 6 is a view showing an example of a print setting table.

FIG. 7 is a view showing an example of a message setting table.

FIG. 8 is a function block diagram showing a function structure of the label printer.

FIG. 9-1 is a view showing an example of a label printed by a first printer.

FIG. 9-2 is a view showing an example of a label printed by a second printer.

FIG. 10 is a view showing another example of a label printed by the first printer.

FIG. 11 is a flowchart showing a procedure of a label print process performed by the label printer.

FIG. 12 is a view showing an electronic inventory tag displaying an emphasis display of the embodiment.

FIG. 13 is a view showing a reference value table for food with nutrient function claims.

FIG. 14 is a view showing an example of a message setting table for food with nutrient function claims.

### DETAILED DESCRIPTION

According to one embodiment, an information output apparatus includes a reception part, a determination part and an information output part. The reception part receives identification information of a product. The determination part reads a content of a nutrient contained in the product having the identification information received by the reception part from a storage part, compares the read content of the nutrient with a reference value indicating a display allowable range in which a display relating to the content of the nutrient may be performed, and determines whether the display relating the content of the nutrient may be performed for the product. When it is determined that the display relating the content of the nutrient may be performed for the product, the information output part outputs information relating to the content of the nutrient.

Besides, according to another embodiment, a label printer includes a reception part, a determination part, an information output part and a printer. The determination part reads a content of a nutrient contained in the product having the identification information received by the reception part from a storage part, compares the read content of the nutrient with a reference value indicating a display allowable range in which a display relating to the content of the nutrient may be performed, and determines whether the display relating the content of the nutrient may be performed for the product. When it is determined that the display relating the content of the nutrient may be performed for the product, the information output part outputs information relating to the content of the nutrient. The printer prints the information relating to the content of the nutrient outputted by the information output part.

Besides, according to still another embodiment, an information output method includes receiving identification information of a product, reading a content of a nutrient contained in the product having the received identification information from a storage part, comparing the read content of the nutrient with a reference value indicating a display allowable range in which a display relating to the content of the nutrient may be performed, determining whether the display relating the content of the nutrient may be performed for the product, and outputting information relating to the content of the nutrient when it is determined that the display relating the content of the nutrient may be performed for the product.

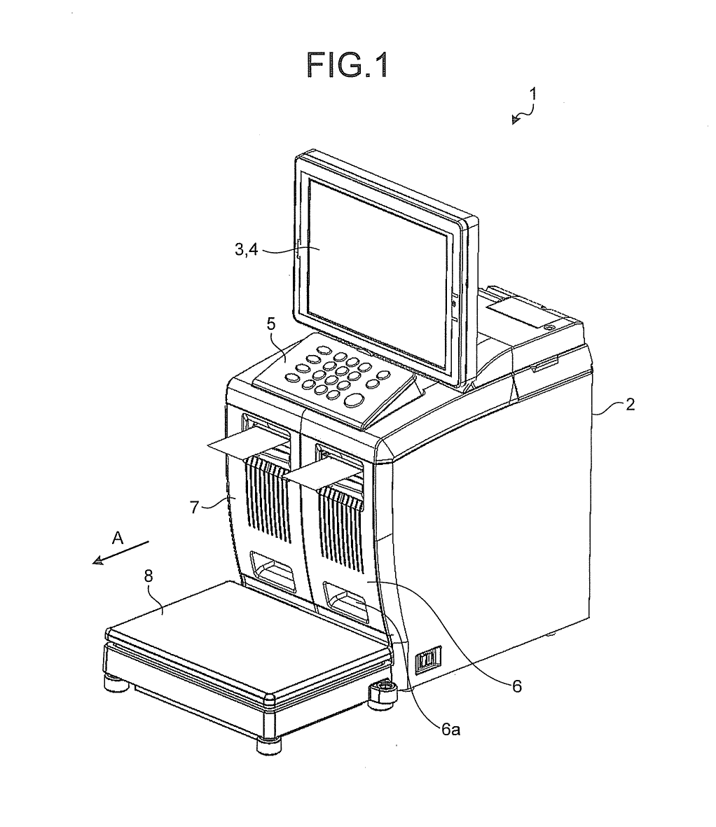

FIG. 1 is a perspective view showing an outer appearance of a label printer 1 of an embodiment. Hereinafter, an example is described in which the information output apparatus of the embodiment is applied to a label printer to issue a label on which information relating to a product such as food is printed.

The label printer 1 prints information relating to a product on a label, and issues the printed label. A display unit such as a liquid crystal display 3 is provided at an upper part of a body 2 of the label printer 1. The liquid crystal display 3 displays a label edit screen for editing product information to be printed on a label. Besides, a touch panel 4 is provided on the surface of the liquid crystal display 3. A keyboard 5 is provided on the upper surface of the body 2 of the label printer 1. A weighing scale 8 on which a product is placed and which weighs the product is provided at a lower part of the front of the body 2 of the label printer 1.

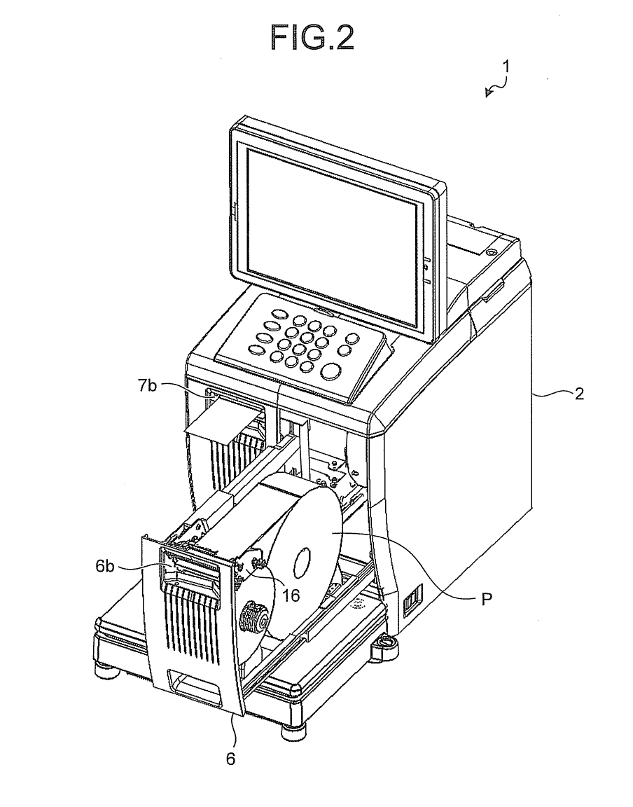

Two printer units, that is, a first printer 6 and a second printer 7 are arranged side by side and are contained in the body 2 of the label printer 1. Since the first printer 6 and the second printer 7 have the same structure, the first printer 6 will be described hereinafter. When a finger is placed in a groove 6a provided at a lower part of a front panel of the first printer 6 and is pulled in a direction A, the first printer 6 can be pulled out from the body 2 as shown in FIG. 2.

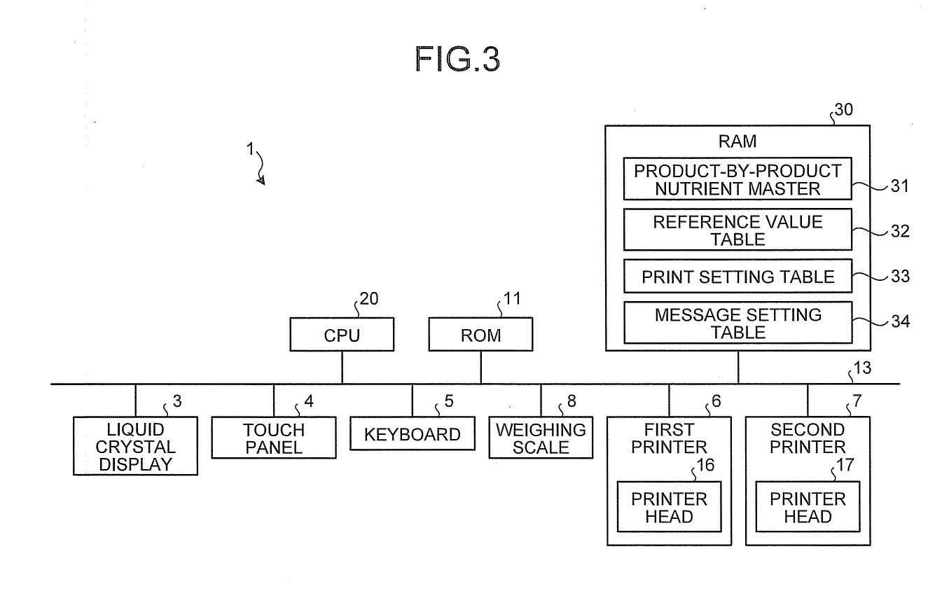

FIG. 2 is a perspective view showing a state where the first printer 6 is pulled out from the body 2. A roll-shaped label sheet P in which labels are pasted on a pasteboard is detachably and attachably held on a not-shown holding shaft in the inside of the first printer 6. Besides, the first printer 6 includes a printer head 16 such as a thermal head. The printer head 16 prints a character, a symbol, a barcode, a two-dimensional code or the like on the label sheet P. The printed label is discharged from a label issue port 6b provided at an upper part of the front panel of the first printer 6. Incidentally, the second printer 7 also includes a label issue port 7b and a printer head 17 (see FIG. 3).

Next, a hardware structure of the label printer 1 will be described. FIG. 3 is a block diagram showing the hardware structure of the label printer 1.

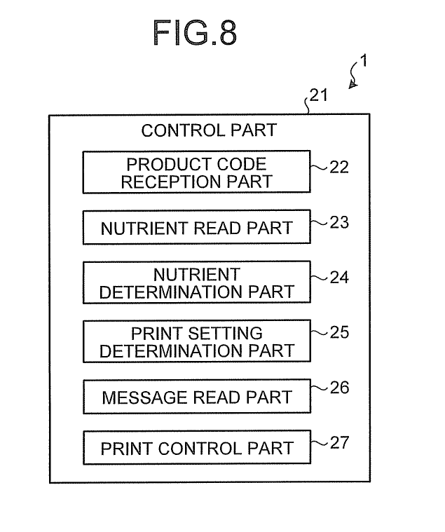

As shown in FIG. 3, the label printer 1 includes a CPU 20, a ROM (Read Only Memory) 11 and a RAM (Random Access Memory) 30, and the respective parts are connected through a bus 13 and various interfaces. The CPU 20 expands a program stored in the ROM 11 into the RAM 30 and executes it, so that the CPU functions as a control part 21 (see FIG. 8) to control the whole system of the label printer 1.

The CPU 20 is connected with the liquid crystal display 3, the touch panel 4, the keyboard 5, the weighing scale 8, the first printer 6 and the second printer 7 shown in FIGS. 1 and 2 through the bus 13 and other interfaces.

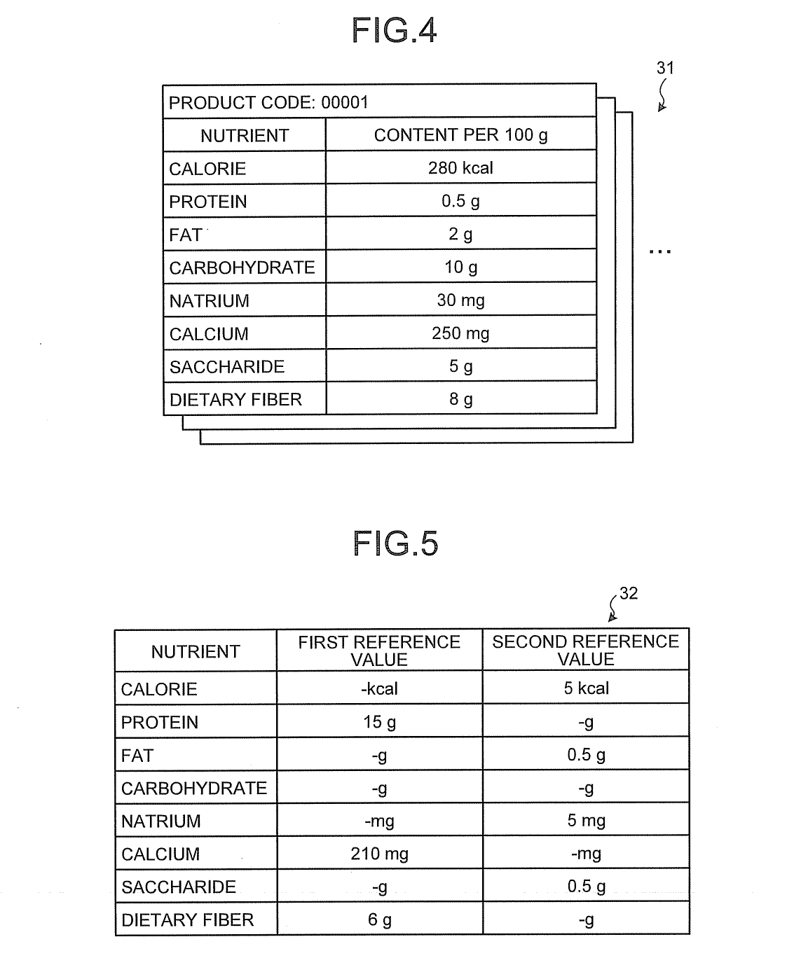

As shown in FIG. 3, the RAM 30 stores a product-by-product nutrient master 31, a reference value table 32, a print setting table 33 and a message setting table 34. Next, these databases will be described with reference to FIG. 4 to FIG. 6.

FIG. 4 is a view for explaining the product-by-product nutrient master 31. As shown in FIG. 4, with respect to a product of each product code, the product-by-product nutrient master 31 sets contents of respective nutrients contained in the product of 100 g. As the nutrients, calorie, protein, fat, carbohydrate, natrium, calcium, saccharide, dietary fiber and the like are set. The setting sequence of these nutrients corresponds to the display sequence when they are displayed on a label.

In general, the emphasis display includes two kinds of displays, that is, a display indicating that a nutrient can be supplied by the product, such as “iron is rich” or “calcium is added”, and a display indicating that adequate intake of the nutrient can be performed by the product, such as “sugar content is zero” or “calorie is low”. Besides, it is prescribed by a guideline of a nutrient display method prescribed by a self-governing community or the like that the emphasis display may be performed only when a specified reference value is satisfied.

Then, in the reference value table 32 of this embodiment, an emphasis display allowable range in which the emphasis display of the nutrient may be performed is set based on the foregoing guideline.

FIG. 5 is a view showing an example of the reference value table 32.

In the reference value table 32, a reference value indicating a display allowable range in which a display relating to a content of each nutrient may be performed is set based on the guideline of each self-governing community. That is, in the reference value table 32, at least one of a first reference value as a lower limit value of the emphasis display allowable range and a second reference value as an upper limit value of the emphasis display allowable range is set for each nutrient.

That is, the first reference value is such a reference value that when a content of a nutrient contained in a product is higher than the value, the emphasis display indicating that the nutrient can be supplied can be performed. As shown in FIG. 5, the first reference value is set for nutrients, such as protein, calcium and dietary fiber, which should be supplied for maintaining and promoting the health.

As shown in FIG. 5, the first reference values for the respective nutrients are set such that the protein is 15 g per 100 g of the product, and calcium is 210 mg per 100 g of the product. In this case, the emphasis display allowable range of protein is the range higher than 15 g per 100 g, and the emphasis display allowable range of calcium is the range higher than 210 mg per 100 g.

The second reference value is such a reference value that when a content of a nutrient contained in a product is lower than the value, the nutrient can be adequately taken. As shown in FIG. 5, the second reference value is set for the nutrients, such as calorie, fat, natrium and saccharide, which should be taken adequately for maintaining and promoting the health.

As shown in FIG. 5, the second reference values for the respective nutrients are set such that calorie is 5 kcal per 100 g of the product, and fat is 0.5 g per 100 g of the product. In this case, the emphasis display allowable range of the calorie is the range less than 5 kcal per 100 g, and the emphasis display allowable range of fat is the range less than 0.5 g per 100 g.

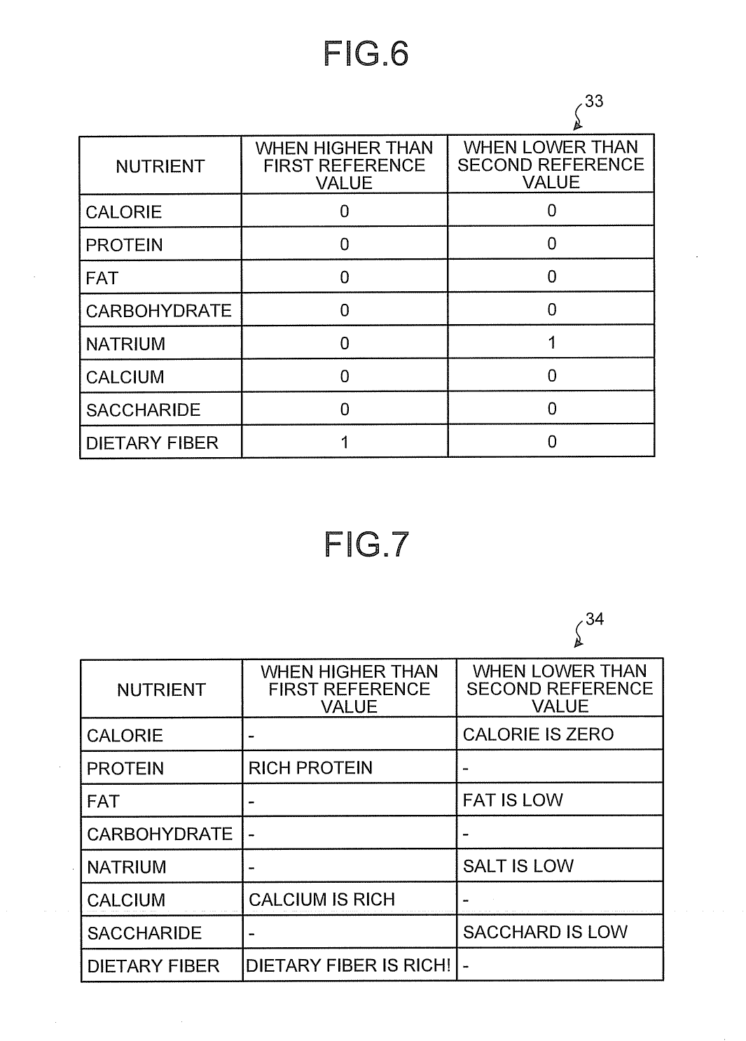

FIG. 6 is a view showing an example of a print setting table 33. The print setting table 33 sets whether a corresponding emphasis display message is printed on a label when a content of a nutrient contained in a product satisfies criteria based on the first reference value or the second reference value (that is, when the content is within the emphasis display allowable range). As shown in FIG. 6, in the print setting table 33, when a message is printed on a label, a flag is set to 1, and when a message is not printed on a label, a flag is set 0. The CPU 20 reads the flag and can determine whether the emphasis display is printed. That is, in the example of FIG. 6, only when dietary fiber is higher than the first reference value, and when natrium is lower than the second reference value, the emphasis display is performed.

By doing so, even when a nutrient satisfies the criteria based on the first reference value or the second reference value, it is can be set for each nutrient whether the emphasis display is performed. Besides, even when plural nutrients satisfy the criteria based on the first reference value or the second reference value, the nutrient for which the emphasis display is performed can be selected. By this, instead of enumerating the plural emphasis displays on the label, the nutrient desired to be emphasized is selected and the emphasis display can be simply performed.

FIG. 7 is a view showing an example of a message setting table 34. In the message setting table 34, respective messages to be displayed on labels are set as information relating to the content of the nutrient. In more detail, as shown in FIG. 7, in the message setting table 34, messages displayed on labels as the emphasis display when the nutrients contained in the product are higher than the first reference value and lower than the second reference value are set for the respective nutrients. For example, as shown in FIG. 7, as the emphasis display for the case where dietary fiber is higher than the first reference value, the message of “Dietary fiber is rich!” is set. Besides, as the emphasis display for the case where fat is lower than the second reference value, the message of “Fat is low” is set.

Next, a function structure of the label printer 1 will be described. FIG. 8 is a function block diagram showing the function structure of the label printer 1. As shown in FIG. 8, the control part 21 of the label printer 1 includes a product code reception part 22, a nutrient read part 23, a nutrient determination part 24, a print setting determination part 25, a message read part 26 and a print control part 27.

When an operator uses the touch panel 4 or the keyboard 5 and inputs a product code through the label edit screen, the product code reception part 22 receives the inputted product code. Besides, when the operator inputs a product name through the label edit screen and searches a product, and the product is selected from the search result, the product code reception part 22 may receive the product code of the product.

The nutrient read part 23 reads the content of each nutrient contained in 100 g of the product having the product code received by the product code reception part 22 from the product-by-product nutrient master 31 (see FIG. 4) into a work area of the RAM 30.

The nutrient determination part 24 determines, for each nutrient, whether the content of each nutrient read into the work area of the RAM 30 by the nutrient read part 23 is within the emphasis display allowable range of each nutrient set by the reference value table 32 (see FIG. 5). That is, the nutrient determination part 24 determines whether the content of the nutrient in the product is higher than the first reference value, or whether the content is lower than the second reference value. In this way, the nutrient determination part 24 determines whether the display relating to the content of the nutrient may be performed for the product.

When the nutrient determination part 24 determines that the content of the nutrient is within the emphasis display allowable range, the print setting determination part 25 reads the value of the flag set for the nutrient from the print setting table 33 (see FIG. 6), and determines whether the flag is 1 or 0.

When the flag is 1, the print setting determination part 25 determines that the message of the emphasis display is outputted to the first printer 6 or the second printer 7, and the message is printed on the label. On the other hand, when the flag is 0, the print setting determination part 25 determines that the message of the emphasis display is not outputted, and the message is not printed on the label.

When the print setting determination part 25 determines that the message is printed, the message read part 26 reads the message set for the nutrient from the message setting table 34 (see FIG. 7) into the print buffer of the RAM 30.

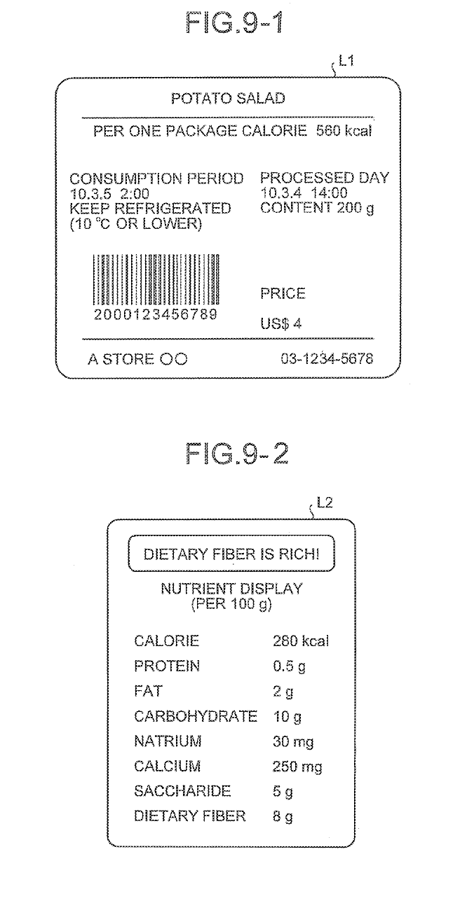

The print control part 27 outputs the message of the emphasis display read by the message read part 26 to the first printer 6 or the second printer 7. Further, the print control part 27 outputs other display data edited on the label edit screen to the printer head 16 and the printer head 17, and prints a label L1 (see FIG. 9-1) and a label L2 (see FIG. 9-2).

FIG. 9-1 is a view showing an example of the label L1 printed by the first printer 6. The print control part 27 prints the label L1, which is generally issued in related art, by the printer head 16 based on the label display data edited on the label edit screen, and issues the label from the label issue port 6b.

FIG. 9-2 is a view showing an example of the label L2 printed by the second printer 7. The print control part 27 prints the display data, such as the message of the emphasis display read into the print buffer of the RAM 30 by the message read part 26 and the contents of the nutrients of the product, on the label L2 by the printer head 17, and issues the label from the label issue port 7b. As shown in FIG. 9-2, the message of the emphasis display of “Dietary fiber is rich!” is printed on the label L2, and the consumer can grasp the feature of the nutrients of the product at a glance.

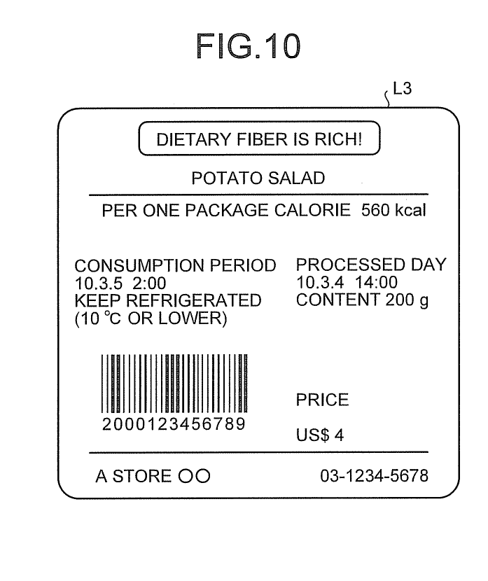

Besides, the print control part 27 uses only one of the first printer 6 and the second printer 7, and may print the message of the emphasis display and other product information on the same label. FIG. 10 is a view showing a label L3 printed by the first printer 6. The print control part 27 controls the first printer 6, and outputs the message read by the message read part 26, together with the other product information, to the printer head 16. The first printer 6 prints the label L3 by the printer head 16, and issues the printed label from the label issue port 6b.

As shown in FIG. 10, the message of the emphasis display of “Dietary fiber is rich!” is printed on the label L3 in addition to the product name, barcode and product price. As stated above, the emphasis display is printed in addition to the related art product display, so that the print area can be made compact. Incidentally, it can be set on the label edit screen whether printing is performed on the two sheets of the label L1 and the label L2 as shown in FIG. 9-1 and FIG. 9-2, or printing is performed on the one sheet of the label L3.

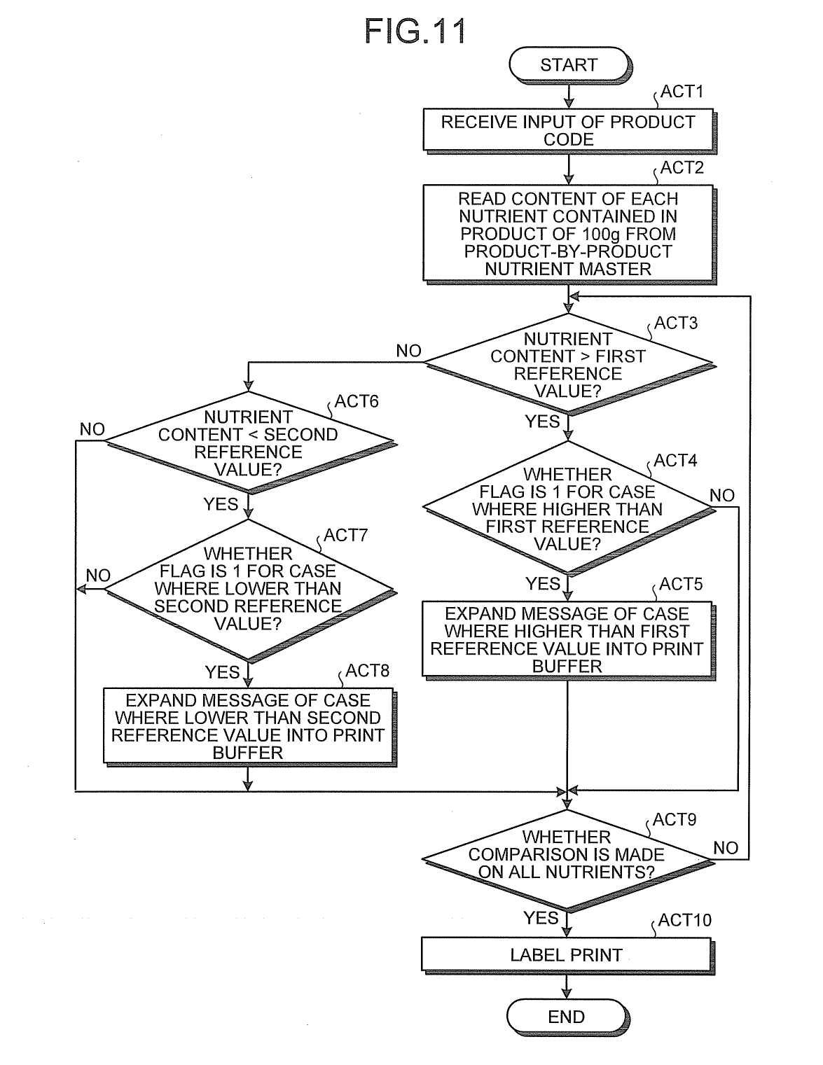

Next, a procedure of a label print process performed by the label printer 1 will be described. FIG. 11 is a flowchart showing the procedure of the label print process performed by the label printer 1.

First, the product code reception part 22 receives input of a product code of a product from the label edit screen displayed on the liquid crystal display 3 (Act 1). The nutrient read part 23 reads the content of each nutrient contained in 100 g of the product having the product code received in Act 1 from the product-by-product nutrient master 31 (see FIG. 4) into the work area of the RAM 30 (Act 2).

The nutrient determination part 24 determines whether the content of the first nutrient (calorie in the example of FIG. 4) is higher than the first reference value per 100 g set in the reference value table 32 (see FIG. 5) (Act 3).

When the content is higher than the first reference value (Act 3: Yes), a shift is made to Act 4. The print setting determination part 25 refers to the print setting table 33 (see FIG. 6), and determines whether the flag is 1 for the case where the content is higher than the first reference value (Act 4). When the flag is 1 (Act 4: Yes), the message read part 26 expands the message, which is set for the case where the content is higher than the first reference value, from the message setting table 34 (see FIG. 7) into the print buffer of the RAM 30 (Act 5). When the flag is 0 (Act 4: No), a shift is made to Act 9.

On the other hand, when the content is lower than the first reference value (Act 3: No), a shift is made to Act 6. The nutrient determination part 24 determines whether the content of the first nutrient is lower than the second reference value per 100 g set in the reference value table 32 (Act 6). When the content is higher than the second reference value (Act 6: No), a shift is made to Act 9. When the content is lower than the second reference value (Act 6: Yes), the print setting determination part 25 refers to the print setting table 33 and determines whether the flag is 1 for the case where the content is lower than the second reference value (Act 7). When the flag is 1 (Act 7: Yes), the message read part 26 expands the message, which is set for the case where the content is lower than the second reference value, from the message setting table 34 (see FIG. 7) into the print buffer of the RAM 30 (Act 8). When the flag is 0 (Act 7: No), a shift is made to Act 9.

In Act 9, the control part 21 determines whether the comparison of the content is performed for all nutrients read into the work area of the RAM 30 in Act 2. When there is a nutrient which is not compared (Act 9: No), a return is made to Act 3, and the control part determines a content of a next nutrient.

When the comparison is performed on all nutrients (Act 9: Yes), the print control part 27 controls the first printer 6 and the second printer 7 and prints the label L1 (see FIG. 9-1) and the label L2 (see FIG. 9-2) (Act 10). Alternatively, the print control part 27 controls the first printer 6 and prints the label L3 (see FIG. 10) (Act 10).

Incidentally, the program executed in the label printer 1 of the embodiment is previously installed in the ROM or the like and is provided. The program executed in the label printer 1 of the embodiment may be recorded as a file of an installable or executable form in a computer readable recording medium such as a CD-ROM, flexible disk (FD), CD-R or DVD (Digital Versatile Disk) and may be provided.

Further, the program executed in the label printer 1 of the embodiment may be stored on a computer connected to a network such as the Internet, and may be provided by download through the network. Besides, the program executed in the label printer 1 of the embodiment may be provided or delivered through a network such as the Internet.

The program executed in the label printer 1 of the embodiment has a module structure including the respective parts (the product code reception part 22, the nutrient read part 23, the nutrient determination part 24, the print setting determination part 25, the message read part 26 and the print control part 27). As the actual hardware, the CPU (processor) reads the program from the ROM and executes it, so that the respective parts are loaded onto the main storage device, and the product code reception part 22, the nutrient read part 23, the nutrient determination part 24, the print setting determination part 25, the message read part 26 and the print control part 27 are generated on the main storage device.

Incidentally, although the example in which the label printer is applied as the information output device is described in the above, no limitation is made to this. The information output apparatus of the embodiment may be applied to another printer to print various information on a recording medium such as a receipt or another sheet.

Besides, in the above, although the product-by-product nutrient master 31, the reference value table 32, the print setting table 33 and the message setting table 34 are stored in the RAM 30 as the storage device, the storage device is not limited to the RAM 30. As another example, a HDD (Hard Disk Drive) is provided in the label printer 1 and the HDD may be used as the storage device.

Besides, the product-by-product nutrient master 31, the reference value table 32, the print setting table 33 and the message setting table 34 are stored in a data server or the like connected to the label printer 1 through a network, and the label printer 1 may read the respective data from the data server through the network.

In the above, although it is determined, based on the value of the flag set in the print setting table 33, whether the message relating to the nutrient is printed on the label, the propriety of label printing may be determined by a determination method other than this. That is, as an example, based on comparison with a reference value, the label printer 1 determines a nutrient most noticeably contained or a nutrient having the lowest content, and may print a message of emphasis display for only the nutrient.

<Other Examples of Emphasis Display>

In the above, when the nutrient is higher than the first reference value, the emphasis display indicating that the nutrient is rich is performed. However, as the emphasis display indicating that the nutrient can be supplied, no limitation is made to this. As another example, a value based on which an emphasis display indicating that the nutrient is contained can be performed is set as a third reference value in the reference value table 32, the message of the emphasis display indicating that the nutrient is contained is set in the message setting table 34, and the display such as “Iron is contained” may be performed.

In the above, when the nutrient is lower than the second reference value, the emphasis display indicating that the nutrient is low is performed. However, as the emphasis display indicating that the nutrient can be adequately taken, no limitation is made to this. As another example, a value based on which the emphasis display indicating that the nutrient is not contained can be performed is set as a fourth reference value in the reference value table 32, the message of the emphasis display indicating that the nutrient is not contained is set in the message setting table 34, and the display such as “Calorie is zero” may be performed.

<Another Mode>

In the above, although the example in which the printer is applied as the information output apparatus is described, no limitation is made to this. As another mode of the information output apparatus, a store server may be applied which outputs display information to an electric inventory tag, a table order terminal or the like and causes the information to be displayed. Specifically, the store server outputs the message of the emphasis display to the display unit such as the electronic inventory tag or the table order terminal, and may cause the display unit to display the message.

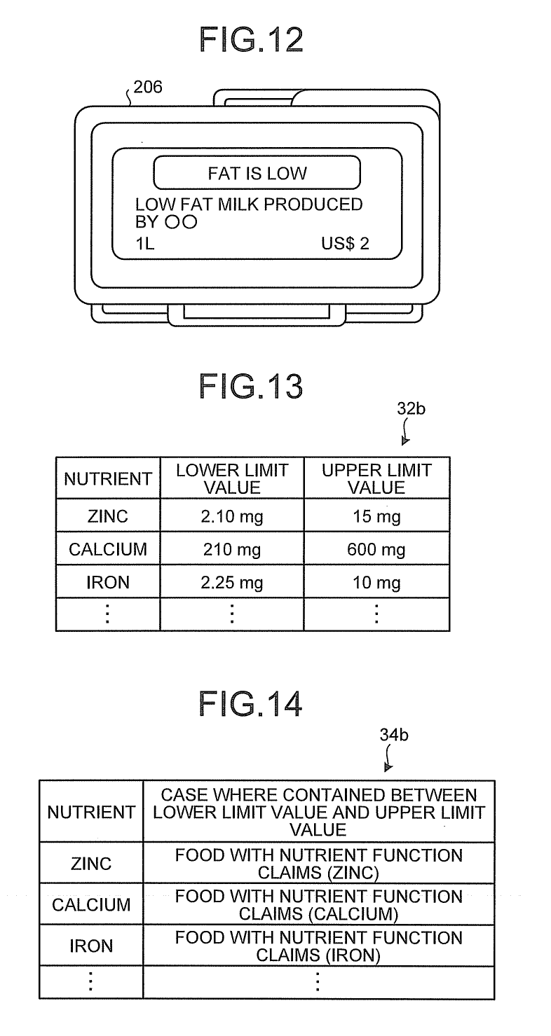

FIG. 12 is a view showing an electronic inventory tag 206 in which an emphasis display is displayed on a display unit. As shown in FIG. 12, the emphasis message is displayed on the electronic inventory tag 206, so that the customer can grasp information on the nutrient at a glance at product purchase. Besides, when the emphasis display message is displayed on the table order terminal, the customer can easily consider the nutrient balance when ordering a menu item.

<Example of Display Other than Emphasis Display>

The display (information) of the content of the nutrient is not limited to the foregoing emphasis display. For example, when a nutrient necessary for maintaining the health, such as mineral or vitamin, meets the criteria prescribed by the self-governing community or the like, it is possible to display that the product is the food with nutrient function claims of the nutrient. Then, as another example of the display relating to the content of the nutrient, the label printer 1 of the embodiment may output the display (information) indicating that the product is the food with nutrient function claims.

In general, the display criteria of the food with nutrient function claims is prescribed based on whether the content of the nutrient is within a specified display allowable range. Then, in this embodiment, in accordance with the display criteria prescribed by the self-governing community or the like, the display allowable range of each nutrient is set in a reference value table 32b by the upper limit value and the lower limit value of the range.

FIG. 13 shows the reference value table 32b for food with nutrient function claims. For example, in the reference value table 32b of FIG. 13, the display allowable range of calcium is set as the range between the lower limit value of 210 mg and the upper limit value of 600 mg. For example, in the intake amount (standard amount) per one day of the product, when the product contains calcium of the lower limit value of 210 mg or higher and the upper limit value of 600 mg or lower, it can be displayed that the product is the food with nutrients function claims of calcium.

FIG. 14 is a view showing an example of a message setting table 34b for food with nutrient function claims. A message indicating that a product is food with nutrient function claims of each nutrient is set in the message setting table 34b.

In this case, it is appropriate that the standard for the intake amount per one day is stored in the product-by-product nutrient master 31 (see FIG. 4).

The nutrient read part 23 compares the standard for the intake amount per one day of each nutrient contained in the product read from the product-by-product nutrient master 31 with the reference value set in the reference value table 32b. When the standard for the intake amount per one day of the nutrient is within the specified range (display allowable range), the label printer 1 determines that the display criteria are satisfied, and outputs the information (for example, “Food with nutrient function claims (calcium)” for the nutrient set in the message setting table 34b.

As described above, the label printer 1 of this embodiment uses the reference value table 32 in which the reference value by which it is determined whether the display is performed is set based on the guideline of the display relating to the content of the nutrient, and determines whether the display of the content of the nutrient is performed. Accordingly, it becomes possible to display the content of the nutrient in accordance with the guideline, and the adequate display relating to the content of the nutrient can be performed.

Further effects and modified examples can be easily derived by those having skill in the art. Thus, the broader form of the invention is not limited to the specific details and the typical embodiments described and set forth in the above. Accordingly, various modifications can be made without departing from the sprit or the scope of the general concept of the invention defined by the attached claims and its equivalent.

What is claimed is:

1. An information output apparatus comprising:
a reception part to receive identification information of a product;
a determination part that reads a content of a nutrient contained in the product having the identification information received by the reception part from a storage part, compares the read content of the nutrient with a reference value indicating a display allowable range in which a display relating to the content of the nutrient may be performed, and determines whether the display relating the content of the nutrient may be performed for the product; and
an information output part that outputs information relating to the content of the nutrient when it is determined that the display relating the content of the nutrient may be performed for the product.

2. The apparatus of claim 1, wherein
the determination part determines whether a content of at least one nutrient contained in the product is higher than a first reference value as a lower limit value of the display allowable range, and
when the content of the nutrient is higher than the first reference value, the information output part outputs information indicating that the nutrient can be supplied by the product.

3. The apparatus of claim 1, wherein
the determination part determines whether a content of at least one nutrient contained in the product is lower than a second reference value as an upper limit value of the display allowable range, and
when the content of the nutrient is lower than the second reference value, the information output part outputs information indicating that the nutrient can be adequately taken in by the product.

4. The apparatus of claim 1, wherein when the content of the nutrient is included in the display allowable range, the information output part outputs information indicating that the product is food with nutrient function claims of the nutrient.

5. The apparatus of claim 1, further comprising an output determination part to determine whether the information output part outputs the information relating to the content of the nutrient when the determination part determines that the display relating the content of the nutrient may be performed for the product.

6. The apparatus of claim 1, wherein the information output part outputs the information relating to the content of the nutrient to a display unit.

7. A label printer comprising:
a reception part to receive identification information of a product;
a determination part that reads a content of a nutrient contained in the product having the identification information received by the reception part from a storage part, compares the read content of the nutrient with a reference value indicating a display allowable range in which a display relating to the content of the nutrient may be performed, and determines whether the display relating the content of the nutrient may be performed for the product;
an information output part that outputs information relating to the content of the nutrient when it is determined that the display relating the content of the nutrient may be performed for the product; and
a printer that prints the information relating to the content of the nutrient outputted by the information output part onto a print medium.

8. The label printer of claim 7, wherein
the determination part determines whether a content of at least one nutrient contained in the product is higher than a first reference value as a lower limit value of the display allowable range, and
when the content of the nutrient is higher than the first reference value, the information output part outputs information indicating that the nutrient can be supplied by the product.

9. The label printer of claim 7, wherein
the determination part determines whether a content of at least one nutrient contained in the product is lower than a second reference value as an upper limit value of the display allowable range, and
when the content of the nutrient is lower than the second reference value, the information output part outputs information indicating that the nutrient can be adequately taken in by the product.

10. The label printer of claim 7, further comprising an output determination part to determine whether the information output part outputs the information relating to the content of the nutrient when the determination part determines that the display relating the content of the nutrient may be performed for the product.

11. The label printer of claim 7, wherein the printer prints the information relating to the content of the nutrient and information relating to the product on one print medium.

12. The label printer of claim 7, wherein the printer prints the information relating to the content of the nutrient and information relating to the product separately on two or more print media.

13. An information output method comprising:
receiving identification information of a product;
reading a content of a nutrient contained in the product having the received identification information from a storage part;
comparing the read content of the nutrient with a reference value indicating a display allowable range in which a display relating to the content of the nutrient may be performed;
determining whether the display relating the content of the nutrient may be performed for the product; and
outputting information relating to the content of the nutrient when it is determined that the display relating the content of the nutrient may be performed for the product.
